(19) United States
(12) Patent Application Publication
(10) Pub. No.: US 2014/0157275 A1
(43) Pub. Date: Jun. 5, 2014

(54) DISTRIBUTED COMPUTING METHOD AND DISTRIBUTED COMPUTING SYSTEM

(71) Applicant: Fujitsu Limited, Kawasaki-shi (JP)

(72) Inventors: Fujiang GE, Beijing (CN); Yingju Xia, Beijing (CN); Yao Meng, Beijing (CN); Hao Yu, Beijing (CN); Wenjie Jia, Beijing (CN); Xiaojian Jia, Beijing (CN)

(73) Assignee: Fujitsu Limited, Kawasaki-shi (JP)

(21) Appl. No.: 14/017,821

(22) Filed: Sep. 4, 2013

Related U.S. Application Data
(63) Continuation of application No. PCT/CN2011/071513, filed on Mar. 4, 2011.

(51) Int. Cl. G06F 9/46

(52) U.S. Cl. CPC G06F 9/46
USPC 718/101

(57) ABSTRACT

A distributed computing method and distributed computing system are provided. Said distributed computing method includes: distributedly computing an input task stream; reducing the computation results of said distributed computation; and storing the reduced computation results in reduction buffers. Said distributed computing system includes distributed computing device which are used for the distributed computation, multiple reduction units which are used for reducing the computation results of said distributed computation, one or more reduction buffer which are used for storing reduced computation results, and a reduction control device which is used for controlling the reduction from said computation results to said reduction buffers and the access to the reduction buffer.

### FIELD OF THE INVENTION

The present invention generally relates to distributed computing and storage and particularly to a method of and apparatus for distributed computing and reducing computing results.

### BACKGROUND OF THE INVENTION

A distributed computing framework is typically designed as a batch processing system. In this distributed system, in order to ensure stability and error recovery of the system, neither status nor data is exchanged between computing units of the same computing step, and data is typically exchanged between different computing steps by writing the data to a disk, e.g., the distributed computing framework Hadoop (http://hadoop.apache.org/) which is the most developed at present. FIG. 1 illustrates such a distributed computing framework. As illustrated in FIG. 1, a distributed computing cluster 1 includes a computing secluding unit 101 and a number k of computing nodes 1, 2 . . . k. A computing node is typically a physical computer or a virtual machine, and there are multiple computing units on each computing node, e.g., a computing unit 1_1, a computing unit 1_2, a computing unit 2_1, a computing unit 2_2, etc.

In the distributed computing framework illustrated in FIG. 1, when a computing task is executed, the computing scheduling unite 101 divides the task into several task segments and starts a computing unit for each task segment to thereby make full use of computing resources of the respective nodes. A computing node writes a result into a disk in the form of a file for use in a subsequent step after finishing its own computing task. The computing results of the task can not be further used until all the computing units have finished their task.

However with the distributed computing framework illustrated in FIG. 1, no partially finished computing result is accessible throughout the computing process, and thus no real-time access to any computing result is possible. For example, a batch of documents is indexed in a real-time retrieval task, and in the traditional distributed computing framework, no retrieval is possible until all the documents in the batch of documents have been indexed. There are typically a huge number of documents to be indexed, and new indexes to the documents are unavailable to retrieval in real time, thus hindering real-time retrieval.

### SUMMARY OF THE INVENTION

The following presents a simplified summary of the invention in order to provide basic understanding of some aspects of the invention. It shall be appreciated that this summary is not an exhaustive overview of the invention. It is not intended to identify key or critical elements of the invention or to delineate the scope of the invention. Its sole purpose is to present some concepts in a simplified form as a prelude to the more detailed description that is discussed later.

In view of the foregoing problem in the prior art, an object of the invention is to provide a distributed computing method and a distributed computing system which can provide a real-time access to computing results finished in distributed computing and store the computing results robustly.

According to an aspect of the invention, there is provided a distributed computing method including: performing distributed computing on an input task stream; reducing computed results of said distributed computing; and storing the reduced computed results into reduction buffers.

According to a particular embodiment of the invention, said reducing step comprising: assigning said computed results to multiple reduction units; performing reduction processing on the computed results assigned to the reduction units; and outputting the computed results subjected to reduction processing to said reduction buffers.

According to a particular embodiment of the invention, said assigning is performed based on reduction values calculated using a reduction function.

According to a particular embodiment of the invention, said assigning is performed based on said reduction values and served task identifiers.

According to a particular embodiment of the invention, said reduction processing further comprises performing post-processing on said computed results.

According to a particular embodiment of the invention, the computed results from the reduction units with the same reduction value are outputted to the same reduction buffer.

According to a particular embodiment of the invention, the computed results of said distributed computing are backuped locally before said reducing step.

According to a particular embodiment of the invention, said computed results are forwarded to the other reduction buffers when a reduction buffer corresponding to a reduction unit can not be written to.

According to a particular embodiment of the invention, the reduction buffer can not be written to when the reduction buffer is reset or refreshed.

According to a particular embodiment of the invention, said computed results subjected to reduction processing are backuped locally when none of the reduction buffers can be written to.

According to a particular embodiment of the invention, said computed results are backuped locally after the computed results subjected to reduction processing are output to reduction buffers.

According to a particular embodiment of the invention, said reduction function comprises a hash function.

According to another aspect of the invention, there is provided a distributed computing system including: a distributed computing device for distributed computing; multiple reduction units for performing reduction processing on computed results of said distributed computing; one or more reduction buffers for storing the reduced computed results; and a reduction controlling device for controlling the reduction of said computed results to said reduction buffers and an access to the reduction buffers.

According to a particular embodiment of the invention, said computed results are assigned to the multiple reduction units based on reduction values calculated using a reduction function.

According to a particular embodiment of the invention, the reduction units with the same reduction value output the computed results subjected to reduction processing to the same reduction buffer.

According to a particular embodiment of the invention, the distributed computing device includes a computing scheduling unit and multiple computing units, where the computing scheduling unit is configured to divide an input task stream into multiple sub-tasks and to assign the multiple sub-tasks to the multiple computing units; and the computing units each include a computing engine and a computing local backup unit, where the computing engine is configured to perform computing, and the computing local backup unit is configured to locally backup a computing result of the computing engine.

According to a particular embodiment of the invention, said reduction buffers comprise a reduction buffer inner control unit and a reduction buffer inner storing unit, said reduction buffer inner control unit receiving an input to the reduction buffer and storing input data into the reduction buffer inner storing unit in a predetermined data structure.

According to a particular embodiment of the invention, at least a part of said reduction buffer inner storing unit is a memory.

According to a particular embodiment of the invention, said reduction units comprise a reduction local backup unit for backuping data processed by the reduction units to restore the reduction buffers when an abnormality occurs in the reduction buffers.

Moreover an embodiment of the invention further provides a computing program for performing the distributed computing method.

Furthermore an embodiment of the invention further provides a computer program product at least in the form of a computer readable medium on which computing program codes for performing the distributed computing method is recorded.

### BRIEF DESCRIPTION OF THE DRAWINGS

The invention can be better understood with reference to the detailed description given below in conjunction with the accompanying drawings throughout which identical or similar reference numerals denote identical or similar components. The drawings together with the following detailed description are incorporated into, and form a part, of this specification and serve to further illustrate preferred embodiments of the invention and to explain the principle and advantages of the invention. In the drawings:

FIG. 1 illustrates a distributed computing framework in the prior art.

FIG. 2 illustrates a schematic structural diagram of a distributed computing system according to the invention.

FIG. 3 illustrates a schematic flow chart of a distributed computing method according to the invention.

FIG. 4 illustrates a particular flow chart of the step S301 in FIG. 3.

FIG. 5 illustrates a particular flow chart of the step S303 in FIG. 3.

FIG. 6 illustrates a particular flow chart of the step S308 in FIG. 3:

FIG. 7 illustrates a schematic flow chart of a read operation on a reduction buffer.

FIG. 8 illustrates an example of an application of the distributed computing system according to the invention in the field of real-time retrieval.

FIG. 9 illustrates a schematic block diagram of a computer in which an embodiment of the invention can be practiced.

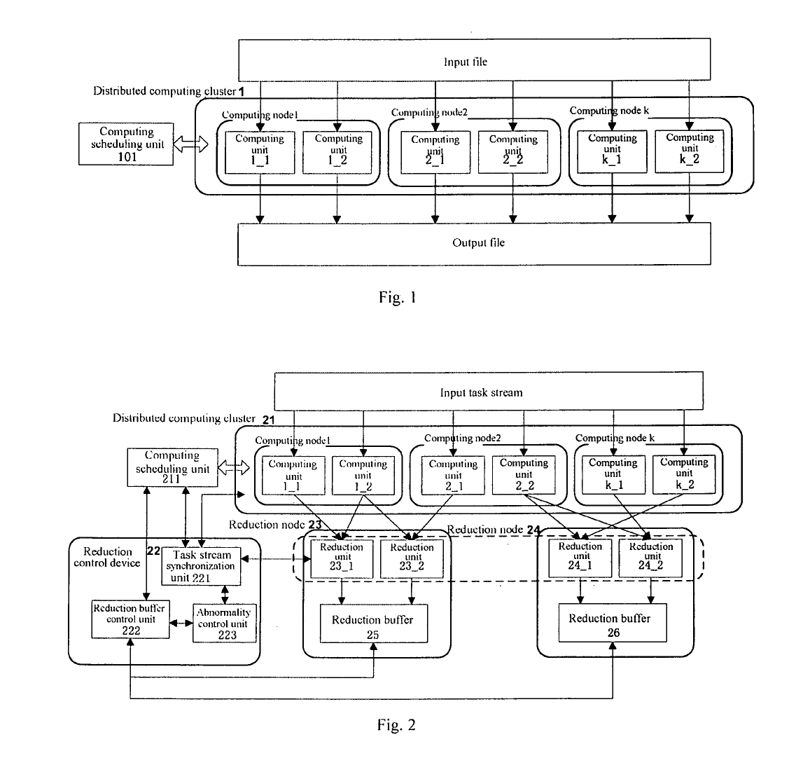

### DETAILED DESCRIPTION OF THE. INVENTION

Embodiments of the invention will be described below with reference to the drawings. An element and a feature described in one drawing or one embodiment of the invention can be combined with an element and a feature illustrated in one or more other drawings or embodiments. It shall be noted that a representation and a description of components and processes, known to those ordinarily skilled in the art, which are irrelevant to the invention, have been omitted for the sake of clarity.

FIG. 2 illustrates a structural diagram of a distributed computing system according to the invention. As illustrated in FIG. 2, the distributed computing system according to an embodiment of the invention includes a distributed computing cluster 21, a reduction control device 22 and one or more reduction nodes 23, 24, etc. The distributed computing cluster 21 includes a computing scheduling unit 211, and one or more computing nodes, each of which includes one or more computing units. The computing scheduling unit 211 is configured to divide a task in an input task stream into multiple sub-tasks and to assign the multiple sub-tasks to the respective computing units for computing. A computing node can be a physical computer or a virtual machine. When the computing node is a virtual machine, respective computing units of the computing node can be distributed on multiple physical computers. The distributed computing cluster 21 can process multiple tasks concurrently.

A reduction node includes one reduction buffer and one or more reduction units. The reduction node can be a physical computer or a virtual machine. When the reduction node is a virtual machine, the reduction buffer and the respective reduction units of the reduction node can be distributed on multiple physical computers. For the reduction unit or units and the reduction buffer physically or logically belonging to the same reduction node, the reduction buffer is a local reduction buffer of the reduction unit or units. It shall be noted that multiple reduction buffers can be arranged in a reduction node although one reduction buffer is arranged in a reduction node to thereby facilitate simplification of reduction processing and also further facilitate organization of data in the reduction buffer into a data structure.

Under the control of the reduction control device 22, a reduction unit receives and performs reduction processing on computing results of computing units (multiple sub-tasks of multiple tasks) and outputs the computing results subjected to reduction processing to the reduction buffer. The reduction unit includes a reduction engine, a reduction unit inner buffer and a reduction local backup unit. The reduction engine performs reduction processing on the computing results input to the reduction unit, and reduction processing in the simplest situation is to store the computing results temporally into the reduction unit inner buffer. Reduction processing can further include post-processing. Post-processing can be user-defined. For example, key sorting and other subsequent processing are performed on the computing results. The reduction local backup unit of the reduction unit is configured to backup data of the reduction unit to recover the reduction buffer when an abnormality occurs in the reduction buffer. Recovery of the reduction buffer will be described below in details.

It shall be noted that a reduction unit is responsible for reducing a part of computing results of a task in the input task stream (i.e., computing results of a part of sub-tasks), that is, a reduction unit reduces computing results of only one task. Computing results of a task are reduced by multiple reduction units due to different reduction values assigned by a reduction function. There is a served task identifier of a reduction unit, and reduction units belonging to the same reduction value are distinguished by served task identifiers. Selection of a reduction unit will be described below in details.

The reduction control device 22 includes a task stream synchronization unit 221, a reduction buffer control unit 222 and an abnormality control unit 223. The task stream synchronization unit 221 is configured to control assignment of the computing results from the computing units to the reduction units and writing by the reduction units to the reduction buffers, the reduction buffer control unit 222 is configured to control an access to the reduction buffer, and the abnormality control unit 223 is configured to control processing of an abnormality in a process of writing and an access to the reduction buffers. It shall be noted that the task stream synchronization unit 221, the reduction buffer control unit 222 and the abnormality control unit 223 are described here as three components of the reduction control device, the reduction control device 22 may not be composed of the foregoing three separate units but instead can have all of its functions performed by a single unit.

A reduction buffer includes a reduction buffer inner control unit and a reduction buffer inner storage unit, and the reduction buffer inner control unit receives an input to the reduction buffer and stores input data into the reduction buffer inner storage unit in a predetermined data structure. The predetermined data structure can be user-defined to accommodate a demand of a different computing task. Particularly at least a part of the reduction buffer inner storage unit is composed of a memory to improve an access speed and facilitate origination of the data structure. The reduction control device 22 maintains a list of reduction buffers for recoding the distribution of reduction data in the reduction buffers.

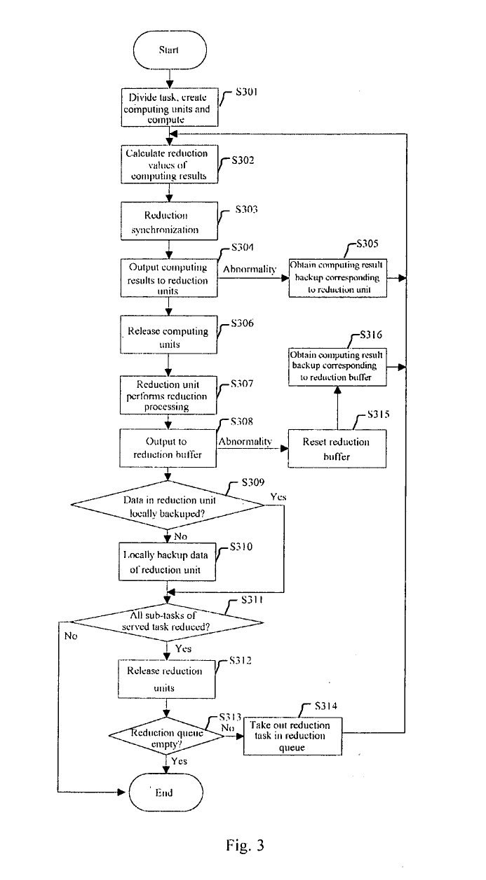

FIG. 3 illustrates a flow chart of a distributed computing method according to the invention. In the step S301, the distributed computing cluster receives an input task, divides the task and creates computing units for computing the task. In the step S302, the computing scheduling unit calculates reduction values for computing results of sub-tasks computed by the computing units using a predetermined reduction function and notifies a task stream synchronization unit of the reduction values. The reduction function can be a hash function, etc. In the step S303, the task stream synchronization unit performs reduction synchronization and selects reduction units using the reduction values and task identifiers. In the step S304, the computing results are output to the reduction units.

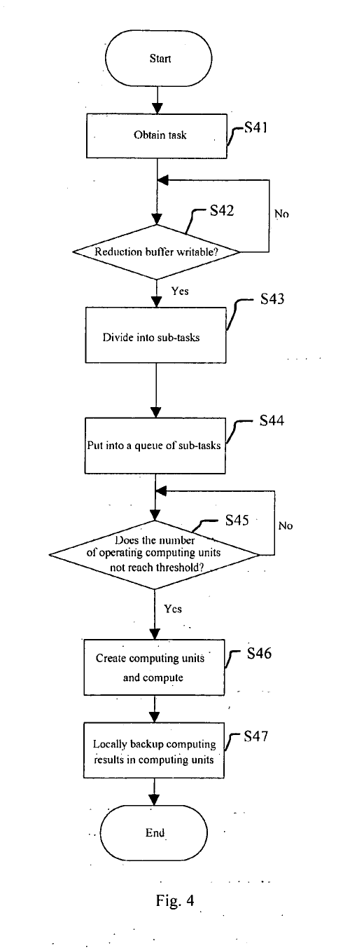

If an abnormality occurs in the step S304, for example, a computing unit loses a computing result therein due to an abnormality, then the flow proceeds to the step S305 where a computing result backup corresponding to the reduction unit is obtained, and the process of the steps S302 to S304 is performed again. Since the backup of the computing result is stored in a computing local backup unit, in the form of a disk, of the computing unit, correctness and integrity of the computing result of the computing unit can be maintained in the case that the computing unit becomes abnormal. A backup of a computing result will be described below with reference to FIG. 4.

In the case that no abnormality occurs in the step S304, the computing units are released in the step S306. It shall be noted that local backup of the computing units are not released at that time. A lifecycle of each computing unit is started since a received sub-task is created until a result of the sub-task is output, successfully to a reduction unit.

It shall be noted that the steps S302 to S306 have been described above by way of an example of a sub-task per task. Since multiple tasks are computed and reduced and each task is divided into multiple sub-tasks, the foregoing steps S302 to S306 are performed for a number of times.

The steps S307 to S311 will be described below taking a reduction unit as an example. In the step S307, the reduction unit Performs reduction processing on the computing results. As described above, the reduction engine in the reduction unit performs reduction processing on computing results, received by the reduction unit, of multiple sub-tasks of a task, and stores them in the reduction unit inner buffer. Reduction processing here in the simplest situation is to store the computing results. The reduction engine can further perform post-processing and other operations on the computing results according user-presetting. Under the control of the task stream synchronization unit, after the reduction unit performs reduction processing on the computing results, to be processed by the reduction unit, of multiple sub-tasks of a task, the reduction unit outputs the computing results to the reduction buffer (the step S308).

It shall be noted that the multiple sub-tasks processed by the reduction unit are input sequentially to the reduction unit in the steps S302 to S306 but not output sequentially to the reduction buffer and instead output together to the reduction buffer after the step S307. On one hand, the reduction engine in the reduction unit may perform post-processing on the computing results in the step S307, and a relationship between the computing results may not be maintained if they are output separately. On the other hand, when the reduction unit outputs its reduced multiple computing results together to the reduction buffer, the computing results are also backuped together to the reduction local backup unit of the reduction unit, and this will facilitate recovery of the reduction buffer by correctly using the reduction local backup unit when an abnormality occurs in the reduction buffer.

If an abnormality occurs in the reduction buffer in the step S308 or in another situation, then under the control of the abnormality control unit of the reduction control device, the reduction buffer is reset (the step S315), and a computing result backup corresponding to the reduction buffer (stored, in the reduction local backup unit of the reduction unit) is obtained according to the list of reduction buffers (the step S316) to recover the reduction buffer before the abnormality occurs. Data of the current reduction unit is reduced again, that is, the flow returns to the step S302.

If no abnormality occurs in the step S308, then it is judged whether the data in the reduction unit has been backuped locally (the step S309), and if not, then the data is backuped locally (the step S310). In the case of “Yes” in the step S309 or after the step S310 is performed, that is, after local backup of the reduction unit is finished, the task stream synchronization unit of the reduction control device judges whether all the sub-tasks of the task serving by the current reduction unit have been reduced (the step S311). If there is “No” in the step S311, then processing on the current reduction unit is terminated.

It shall be noted that multiple sub-tasks of a task are reduced into different reduction units by the user-preset reduction function. The other reduction units serving the task will also-perform the steps S307 to S311 concurrently or subsequently.

If there is “Yes” in the step S311, then all the reduction units serving the task are released (the step S312), and the flow proceeds to the step S313. In the step S303, some computing results may be put into a reduction queue instead of being output to the reduction unit because the number of reduction units reaches a threshold. Thus in the step S312, after the reduction units are released, it is judged whether the reduction queue is empty (the step S313), and if not, then a reduction task in the reduction queue is taken out (the step S314), and the flow proceeds to the step S302 to reduce the taken-out reduction task. If there is “Yes” in the step S313, then processing is terminated.

The step S301 in FIG. 3 will be described below in details with reference to FIG. 3. The distributed computing cluster obtains the multiple tasks in the input task stream (the step S41). The computing scheduling unit judges whether there is at least one reduction buffer in a writable status (the step S42), and if none of the reduction buffers is writable, then this process is further cycled waiting until there is at least one reduction buffer in a writable status; or if there is at least one reduction buffer in a writable status, then one of the tasks is divided into multiple sub-tasks (the step S43), and the multiple sub-tasks are put into a queue of sub-tasks (the step S44).

Since distributed computing can process the multiple tasks concurrently, there are multiple sub-tasks of the multiple tasks in the queue of sub-tasks. The computing scheduling unit judges whether the number of operating computing units does not reach a threshold (the step S45), and if so, then it further waits until there is negative judgment; or when it is judged that the number of computing units does not reach the threshold, a computing unit is created and a sub-task in the queue of sub-tasks is computed by the computing unit (the step S46). The computing unit includes a computing engine and a computing local backup unit, where the computing engine is configured to perform computing, and the computing local backup unit is configured to backup a computing result, after the computing unit performs computing and before it outputs the computing result, to thereby provide the computing result backup used in the step S305 in FIG. 3 (the step S47).

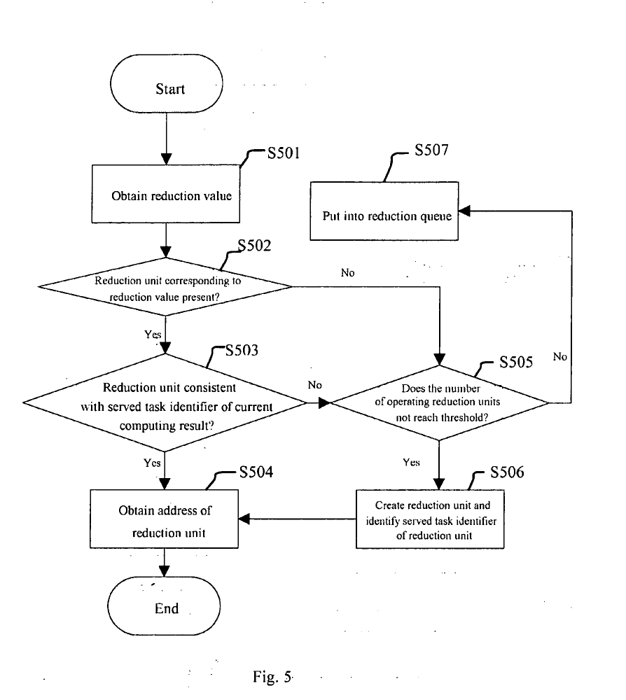

The step S303 in FIG. 3 will be described below in details with reference to FIG. 5. The task stream synchronization unit obtains a reduction value calculated by the computing scheduling unit using the predetermined reduction function (the step S501), judges whether a reduction unit corresponding to the reduction value is present (the step S502), and if so, it is judged whether a served task identifier of the reduction unit is consistent with a served task identifier of the current computing result (the step S503), and if so, then the address of the reduction unit is obtained (the step S504). That is, only if a reduction unit with both a reduction value and a served task identifier thereof consistent with those of the current computing result is found, then the address of the reduction unit will be obtained. Otherwise (that is, “No” in either of S502 and S503), it is judged whether the number of operating reduction units does not reach a threshold (the step S505), and if not, then a reduction unit is created, and a reduction value and a served task identifier of the reduction unit are set as a reduction value and a served task identifier of the current computing result (the step S506).

When there is “No” in the step S505, the current reduction task is put into the reduction queue (the step S507). A task identifier identifies a task, and a reduction unit is responsible for reducing computing results of only one task and provided with a unique task identifier. Reduction values function to reduce computing results of multiple sub-tasks of the same task into multiple reduction units and further into different reduction buffers. A user can preset the reduction function for particular setting, for example, a reduction function can be set in an indexing application so that index data to words starting with a to g is put into a first reduction buffer, indexes to words starting with h to n are put into a second reduction buffer, etc. Multiple reduction units of the same task are provided with different reduction values and can correspond to different reduction buffers. Reduction units with the same reduction value are distinguished from each other by served task identifiers. Reduction units with the same reduction value output results of reduction processing to the same reduction buffer. The use of reduction values to distribute computing results of distributed computing to multiple reduction units can further function to decentralize a computing load.

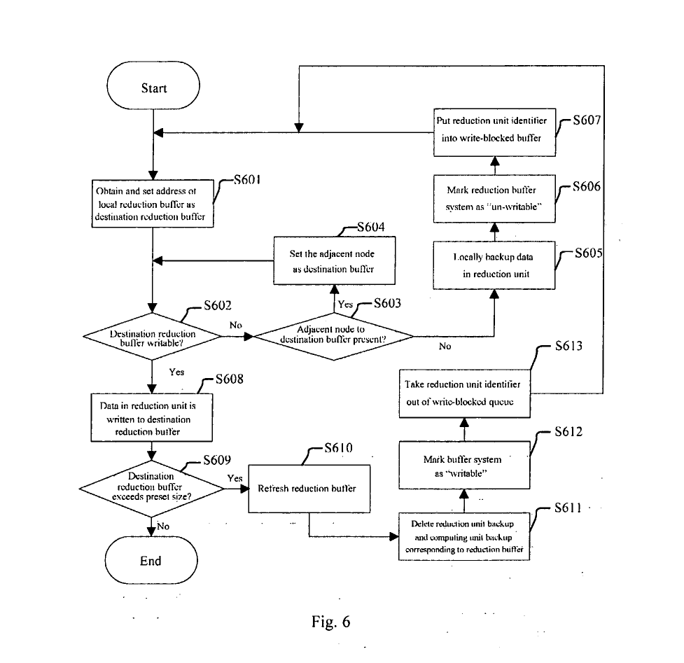

The step S308 in FIG. 3 will be described below in details with reference to FIG. 6. Firstly the address of a local reduction buffer is obtained and set as a destination reduction buffer (the step S601). As described above, for a reduction unit, a reduction buffer belonging to the same reduction node is a local reduction buffer of the reduction unit and taken as a preferred destination reduction buffer thereof. Of course, when the reduction node is a virtual machine, the local reduction buffer of the reduction unit may reside in another physical computer.

Thereafter it is judged whether the destination reduction buffer is writable (the step S602), and as described above, the reduction buffer is in an un-writable status upon being reset due to an abnormality occurring. As further described below, the reduction buffer is also in an un-writable status upon being refreshed. The reduction buffer is in an un-writable status only in these two cases.

In the case that it is judged in the step S602 that the destination reduction buffer system is not writable, it is judged whether there is an adjacent node to the reduction node to which the destination buffer belongs (the step S603), and if it is judged that there is an adjacent node, then a reduction buffer of the adjacent node is set as a destination reduction buffer (the step S604), and the flow returns to the step S602 for processing. That is, when the destination reduction buffer is not writable, data of the reduction unit can be written into the redirected reduction buffer. The so-called adjacency can refer to physical adjacency or logical adjacency dependent user-setting. For example, the user store and maintain the addresses of the respective reduction nodes in a linked list in which the last entry of data is the first entry of data in the linked list, where an adjacent node to a reduction node is the next node to the reduction node in the linked list. If the adjacent node to the reduction node is itself, then it is judged that there is no adjacent node to the reduction node. Since data of the reduction unit may be redirected for being writing into another reduction buffer, the reduction buffer inner control unit maintains a redirection list to record such a situation for use by the reduction buffer control unit in an access to the reduction buffers.

If it is judged in the step S603 that there is no adjacent node to the destination buffer, it indicates that there is no writable reduction buffer in the current reduction buffer system, so the data of the reduction unit is backuped to the reduction local backup unit (the step S605), the reduction buffer system is marked as “un-writable” (the step S606), and the identifier of the reduction unit is put into a write-blocked queue (the step S607). As further described below, when the reduction buffer system is writable, the identifier of the reduction unit will be taken out of the write-blocked queue, and the step S308 in FIG. 3 will be performed again.

If it is judged in the step S602 that the destination buffer is writable, then the data in the reduction unit is written into the destination reduction buffer (the step S608). After writing, it is judged whether the destination reduction buffer exceeds a preset size (the step S609), and if not, then the data is output correctly to the reduction buffer, and the step S308 in FIG. 3 is ended normally; or if so, then the flow proceeds to the step S610 where the reduction buffer is refreshed.

It shall be noted that although the reduction buffer is not writable upon being refreshed, the entire reduction buffer system may not necessarily be un-writable at that time. The size of the reduction buffer can be user-preset, and when the preset size is exceeded, the reduction buffer is refreshed by writing all of existing data in the reduction buffer to the disk. It shall be noted that although the data is written to the disk, the data structure of the data is still reserved in the list of reduction buffers to thereby facilitate an external access to the data in the data structure through the reduction buffer control unit. Since the data is stored in a hard disk, the data will not be influenced by a possible abnormality of the reduction buffer, so the local backup of the reduction unit and the local backup of the computing unit corresponding to the reduction buffer are deleted (the step S611).

Due to the presence of the refreshed reduction buffer, there is at least one writable reduction buffer in the reduction buffer system, so the reduction buffer system is marked as “writable” (the step S612), and the identifier of a reduction unit is taken out of the write-blocked queue (the step S613) to perform a write operation of another reduction unit to the reduction buffer system.

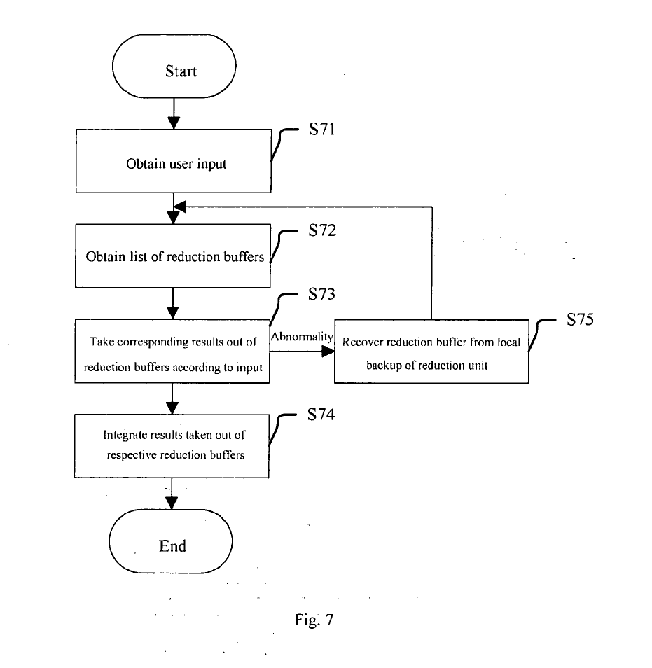

A read operation on a reduction buffer will be described below in details with reference to FIG. 7. The reduction buffer control unit obtains an input of the user (the step S71), obtains the list of reduction buffers (the step S72), obtains corresponding results from reduction buffers according to the input by referring to the list (the step S73) and integrates the results taken out of the respective reduction buffers (the step S74). If an abnormality occurs in a reduction buffer, then the reduction buffer is recovered from a local backup of the reduction unit (the step S75). Particularly in the step S73, the results can be taken out of the respective reduction buffers in parallel, or the results can be taken out of the respective reduction, buffers serially. Due to the presence of redirection, a reduction buffer may obtain data by accessing another reduction buffer according to the redirection list in the step S73.

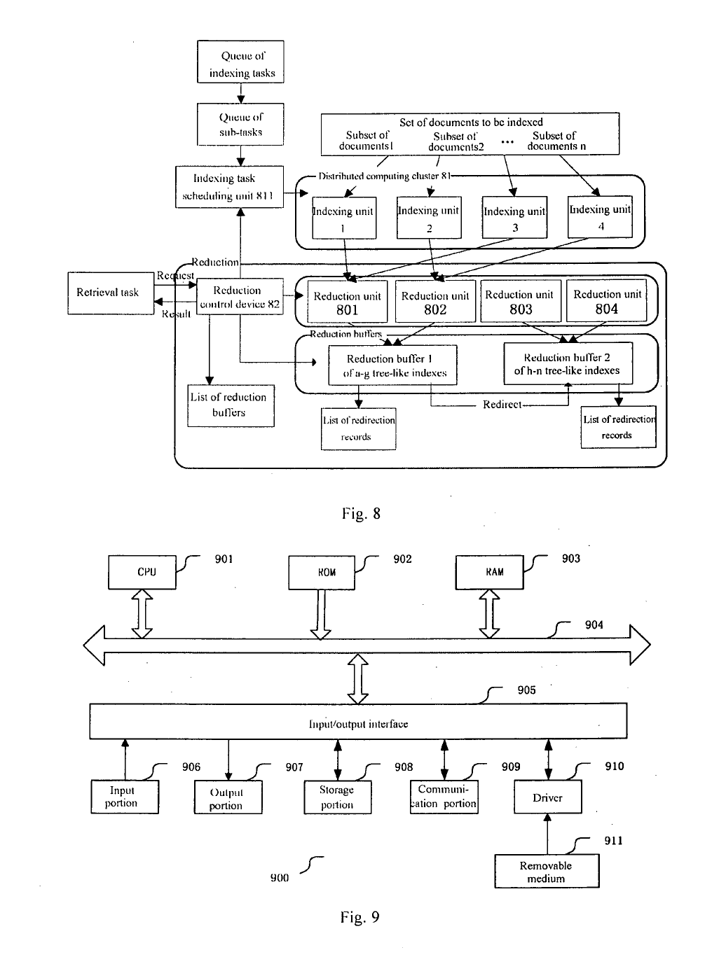

FIG. 8 illustrates an example of an application of the distributed computing method and the distributed computing system according to the invention in the field of real-time retrieval. Firstly creation of inverted indexes will be introduced. For example, a sub-task is input in the format of <a word, a document identifier of a document in which the word appears>. Assumed the document 1(d1) includes the words of t1, t2 and t3; and the document 2(d2) includes the words of t1, t3 and t4. Inverted indexes of these two documents are calculated in the following format:
t1:d1
t1:d2
t2:d1
t3:d1
t3:d2
t4:d2

After reduction, the indexes are arranged into the following format:
t1:d1,d2
t2:d1
t3:d1,d2
t4:d2

In order to further organize the indexes, the indexes of t1 and t2 are put into a reduction buffer, and the indexes of t3 and t4 are put into another reduction buffer. Also in order to process a large amount of data, the data in the two reduction buffers is organized in a tree-like structure for convenient lookup. A schematic flow of a particular implementation for the foregoing process will be described below.

Tasks in a distributed processing framework of real-time retrieval are categorized into two categories: indexing tasks and retrieval tasks. An index task relates to a set of document, for example, 10 thousands of documents to be indexed. In a real-time context, a new set of document may be constantly added to a queue of indexing tasks. An indexing task scheduling unit 811 (the computing scheduling unit) divides each indexing task (i.e., a set of documents) into several sub-tasks (subsets of documents) according to computing resources (memories, CPU times, etc.) possessed by computing units (indexing units 1, 2, . . . ) in a distributed computing cluster 81 and initializes several computing units for computing, where each computing unit is responsible for computing tasks of an indexing sub-task (document parsing, word segmentation, inverted sorting, etc). After computing, preliminary inverted indexes are created, and the inverted indexes of the same words are put together.

The reduction units 801 and 802 share the reduction buffer 1, and the reduction units 803 and 804 share the reduction buffer 2. The user can set the reduction function so that reduction values of words starting with “a” and words starting with “b” correspond to the reduction buffer 1, and reduction values of words starting with “h” and words starting with “i” correspond to the reduction buffer 2. Thus the reduction unit 801 processes the indexes of the words starting with “a”, the reduction unit 802 processes the indexes of the words starting with “b”, the reduction unit 803 processes the indexes of the words starting with “h”, the reduction unit 804 processes the indexes of the words starting with “i”, etc.; and also the reduction buffer 1 stores the indexes of the words starting with a to g, and the reduction buffer 2 stores the indexes of the words starting with h to n, and the reduction buffers maintain their own tree-like index structures and read and write accesses thereto.

Particularly a reduction unit receives multiple computing results of the same task, and since the multiple computing results come from different computing units, at least the multiple computing results will be stored in reduction processing by the reduction unit. Also dependent upon a need of and a setting by the user, post-processing is performed on the received computing results in reduction processing, e.g., key sorting of the computing results (sorting in the order of t1, t2, t3 . . . ), etc. A reduction unit reduces computing results of only one task, and this is done by a served task identifier. When the computing results are assigned to the reduction unit, the, computing results are further compared with the served task identifier of the reduction unit for consistency. After all of sub-tasks of a task have been subjected to reduction processing, the reduction unit reducing the task is released. Since more than one task is input, and a new task is constantly added, both the computing unit and the reduction unit have more than one task being computed and reduced concurrently. There is an identical key entry across the different tasks, for example, reduction values calculated from the indexes of words starting with “a” using the reduction function are assigned to different reduction units corresponding to the same reduction buffer. This enables the final computing results of the respective tasks to be integrated into the data structure in the reduction buffer as needed for the setting by the user. Each task can be accessed for retrieval immediately after being reduced to a reduction buffer. If a retrieval task is received, a reduction control device 82 accesses the reduction buffers according to the list of reduction buffers and returns an access result to a requester of the retrieval task.

The respective constituting modules and units in the foregoing apparatus can be configured in software, firmware, hardware or any combination thereof. Particular configuration means or schemes available are well known to those skilled in the art and the detailed description thereof is omitted here. In the case of being embodied in software or firmware, program constituting the software can be installed from a storage medium or a network to a computer with a dedicated hardware structure (e.g., a general-purpose computer 900 illustrated in FIG. 9) which can perform various functions or the like when various pieces of programs are installed thereon.

In FIG. 9, a Central Processing Unit (CPU) 901 performs various processes according to program stored in a Read Only Memory (ROM) 902 or loaded from a storage portion 908 into a Random Access Memory (RAM) 903 in which data required when the CPU 901 performs the various processes, etc., is also stored as needed. The CPU 901, the ROM 902 and the RAM 903 are connected to each other via a bus 904 to which an input/output interface 905 is also connected.

The following components are connected to the input/output interface 905: an input portion 906 (including a keyboard, a mouse, etc.), an output portion 907 (including a display, e.g., a Cathode Ray Tube (CRT), a Liquid Crystal Display (LCD), etc., a speaker, etc.), a storage portion 908 (including a hard disk, etc.) and a communication portion 909 (including a network interface card, e.g., an LAN card, a modem, etc). The communication portion 909 performs a communication process over a network, e.g., the Internet. A driver 910 is also connected to the input/output interface 905 as needed. A removable medium 911, e.g., a magnetic disk, an optical disk, an optic-magnetic disk, a semiconductor memory, etc., can be installed on the driver 910 as needed so that computer program fetched therefrom can be installed into the storage portion 908 as needed.

In the case that the foregoing series of processes are performed in software, program constituting the software can be installed from a network, e.g., the Internet, etc., or a storage medium, e.g., the removable medium 911, etc.

Those skilled in the art shall appreciate that such a storage medium will not be limited to the removable medium 911 illustrated in FIG. 9 in which the program is stored and which is distributed separately from the apparatus to provide a user with the program. Examples of the removable medium 911 include a magnetic disk (including a Floppy Disk (a registered trademark)), an optical disk (including Compact Disk-Read Only memory (CD-ROM) and a Digital Versatile Disk (DVD)), an optic-magnetic disk (including a Mini Disk (MD) (a registered trademark)) and a semiconductor memory. Alternatively the storage medium can be the ROM 902; a hard disk included in the storage portion 908, etc., in which the program is stored and which is distributed together with the apparatus including the same to the user.

Furthermore the invention further proposes a product program on which machine readable instruction codes are stored. The instruction codes can perform the foregoing method according to the embodiment of the invention upon being read and executed by a machine.

Correspondingly a storage medium carrying the foregoing program product on which the machine readable instruction codes are stored will also be encompassed in the disclosure of the invention. The storage medium includes but will not be limited to a floppy disk, an optical disk, an optic-magnetic disk, a memory card, a memory stick, etc.,

In the foregoing description of the particular embodiments of the invention, a feature described and/or illustrated with respect S to an implementation can be used identically or similarly in one or more other implementations in combination with or in place of a feature in the other implementation(s).

It shall be emphasized that the term “including/comprising” as used in this context refers to the presence of a feature, an element, a step or a component but does not preclude the presence or addition of one or more other features, elements, steps or components.

Furthermore the method according to the invention will not necessarily be performed in a chronological order described in the specification but can alternatively be performed in another chronological order sequentially, concurrently or separately. Therefore the technical scope of the invention will not be limited by the order in which the method is performed as described in the specification.

Although the invention has been disclosed above in the description of the particular embodiments of the invention, it shall be appreciated that all the foregoing embodiments and examples are illustrative but not limiting. Those skilled in the art can devise various modifications, adaptations or equivalents to the invention without departing from the spirit and scope of the appended claims. These modifications, adaptations or equivalents shall also be regarded as coming into the claimed scope of the invention.

1. A distributed computing method, comprising:
performing distributed computing on an input task stream;
reducing computed results of said distributed computing; and
storing the reduced computed results into reduction buffers.

2. A distributed computing method according to claim 1, wherein said reducing step comprising:
assigning said computed results to multiple reduction units;
performing reduction processing on the computed results assigned to the reduction units; and
outputting the computed results subjected to the reduction processing to said reduction buffers.

3. A distributed computing method according to claim 2, wherein said assigning is performed based on reduction values calculated using a reduction function.

4. A distributed computing method according to claim 3, wherein said assigning is performed based on said reduction values and served task identifiers.

5. A distributed computing method according to claim 2, wherein said reduction processing further comprises performing post-processing on said computed results.

6. A distributed computing method according to claim 2, wherein the computed results from the reduction units with the same reduction value are outputted to the same reduction buffer.

7. A distributed computing method according to claim 1, wherein the computed results of said distributed computing are backuped locally before said reducing step.

8. A distributed computing method according to claim 2, wherein said computed results are forwarded to other reduction buffers when a reduction buffer corresponding to a reduction unit can not be written to.

9. A distributed computing method according to claim 8, wherein the reduction buffer can not be written to when the reduction buffer is reset or refreshed.

10. A distributed computing method according to claim 2, wherein said computed results subjected to the reduction processing are backuped locally when none of the reduction buffers can be written to.

11. A distributed computing method according to claim 2, wherein said computed results are backuped locally after the computed results subjected to the reduction processing are output to reduction buffers.

12. A distributed computing method according to claim 3, wherein said reduction function comprises a hash function.

13. A distributed computing system, comprising:
a distributed computing device for performing distributed computing;
multiple reduction units for performing reduction processing on computed results of said distributed computing;
one or more reduction buffers for storing the reduced computed results; and
a reduction controlling device for controlling the reduction of said computed results to said reduction buffers and an access to the reduction buffers.

14. A distributed computing system according to claim 13, wherein said computed results are assigned to the multiple reduction units based on reduction values calculated using a reduction function.

15. A distributed computing system according to claim 14, wherein the reduction units with the same reduction value output the computed results subjected to the reduction processing to the same reduction buffer.

16. A distributed computing system according to claim 13, wherein said reduction buffers comprise a reduction buffer inner control unit and a reduction buffer inner storing unit, said reduction buffer inner control unit receiving an input to the reduction buffer and storing input data into the reduction buffer inner storing unit in a predetermined data structure.

17. A distributed computing system according to claim 16, wherein at least a part of said reduction buffer inner storing unit is a memory.

18. A distributed computing system according to claim 13, wherein said reduction units comprise a reduction local backup unit for backuping data processed by the reduction units to restore the reduction buffers when an abnormality occurs in the reduction buffers.
